(19) United States
(12) Patent Application Publication
(10) Pub. No.: US 2023/0019287 A1
(43) Pub. Date: Jan. 19, 2023

(54) Validation of Freight Carrier Account Numbers in E-Commerce Orders

(71) Applicant: Texas Instruments Incorporated, Dallas, TX (US)

(72) Inventors: Harmanpreet Singh Grewal, Plano, TX (US); Paul G Morken, Broomfield, CO (US); Nikhil Kumar Deshidi, Frisco, TX (US)

(21) Appl. No.: 17/503,123

(22) Filed: Oct. 15, 2021

Related U.S. Application Data
(60) Provisional application No. 63/222,850, filed on Jul. 16, 2021.

(51) Int. Cl. G06Q 10/08; G06Q 30/06

(52) U.S. Cl. CPC G06Q 10/0834; G06Q 30/0609; G06Q 10/08355; G06Q 30/0633; G06Q 2250/05; G06Q 20/401

(57) ABSTRACT

A method is provided that includes receiving, by a first device from a second device, a freight carrier for shipping a product and an account number for the freight carrier, validating, by the first device, the account number by communicating with a third device, and allowing, by the first device, completion of checkout on the second device in response to successfully validating the account number.

### CROSS-REFERENCE TO RELATED APPLICATIONS

This application claims benefit of U.S. Provisional Patent Application No. 63/222,850 filed Jul. 16, 2021, which application is hereby incorporated herein by reference in its entirety.

### BACKGROUND

Websites for e-commerce companies may require a customer to provide a freight carrier account number in advance of placing orders to allow time for validation and/or delay shipment of an order until a freight carrier account number entered when the order is placed can be validated with the carrier, which is usually a manual process. In some cases, customers cannot use a freight carrier account and the e-commerce websites estimate shipping costs or provide a flat rate shipping cost, which may result in shipping subsidies incurred by the companies when the actual shipping costs are more than the estimated or flat rate shipping costs.

### SUMMARY

Embodiments of the present disclosure relate to validation of freight carrier account numbers in e-commerce orders. In one aspect, a method is provided that includes receiving, by a first device from a second device, a freight carrier for shipping a product and an account number for the freight carrier, validating, by the first device, the account number by communicating with a third device, and allowing, by the first device, completion of checkout on the second device in response to successfully validating the account number.

In one aspect, a first device is provided that includes at least one processor, wherein the at least one processor is configured to receive a freight carrier for shipping a product and an account number for the freight carrier during a checkout process initiated by a second device, and communicate with a third device to validate the account number before the checkout process can be completed by the second device.

In one aspect, a method is provided that includes displaying a checkout graphical user interface (GUI) responsive to a customer request to enter a checkout process, by at least one processor on a first device, receiving, by the at least one processor, customer selection of a freight carrier and an account number for the freight carrier in the checkout GUI, validating the account number by the at least one processor by communicating with a second device, and displaying, by the at least one processor, an interface to complete the checkout process in the checkout GUI when the second device indicates the account number is valid.

### BRIEF DESCRIPTION OF THE DRAWINGS

FIG. 1 is a flow diagram of a method for real-time validation of a freight carrier account number during an e-commerce order;

FIGS. 2A-2E are excerpts of an example graphical user interface (GUI);

FIG. 3 is a block diagram of an example system configured to perform real-time validation of freight carrier account numbers during an e-commerce order;

FIG. 4 is a block diagram illustrating an example e-commerce website architecture configured to provide real-time validation of freight carrier account numbers; and

FIG. 5 is a block diagram of an example digital system.

### DETAILED DESCRIPTION

Specific embodiments of the disclosure are described herein in detail with reference to the accompanying figures. Like elements in the various figures are denoted by like reference numerals for consistency.

Embodiments of the disclosure provide for real-time validation of a customer account with a freight carrier when a customer places an order on an e-commerce website. In some embodiments, when a customer places an order on an e-commerce website, the customer may specify a freight carrier for delivery of the order item(s) together with the customer's account number with the freight carrier, and the account number is submitted to the freight carrier for validation in real-time, i.e., while the customer waits to complete the order. If the account number is validated, the customer may complete the order and the item(s) will be delivered by the freight carrier and the shipping costs will be charged to the validated account number. If the account number is not validated, the customer is prompted to enter a valid account number or select another shipping option.

This real-time account number validation allows customers to select the desired freight carrier and use their own account numbers, which may eliminate accounting issues incurred when a customer is required to use a shipping method selected by the e-commerce company. Also, using a customer account number may reduce shipping subsidies incurred by the e-commerce company as the actual shipping cost can be charged to the customer account number.

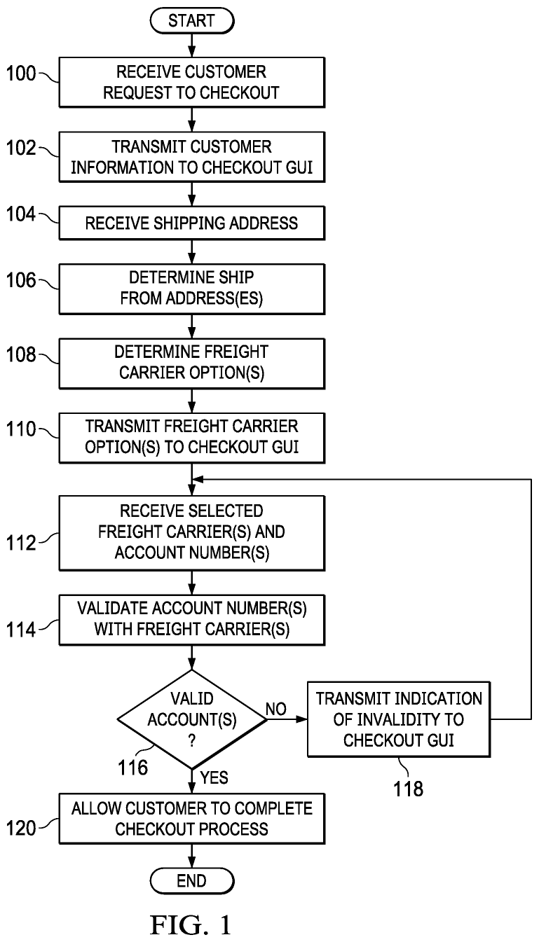

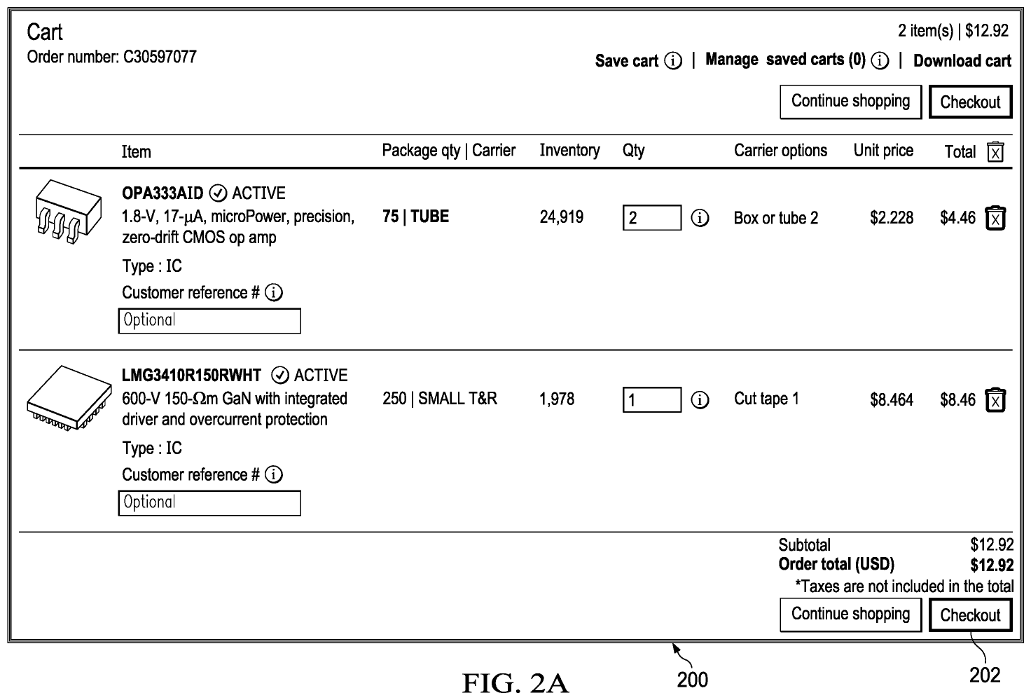

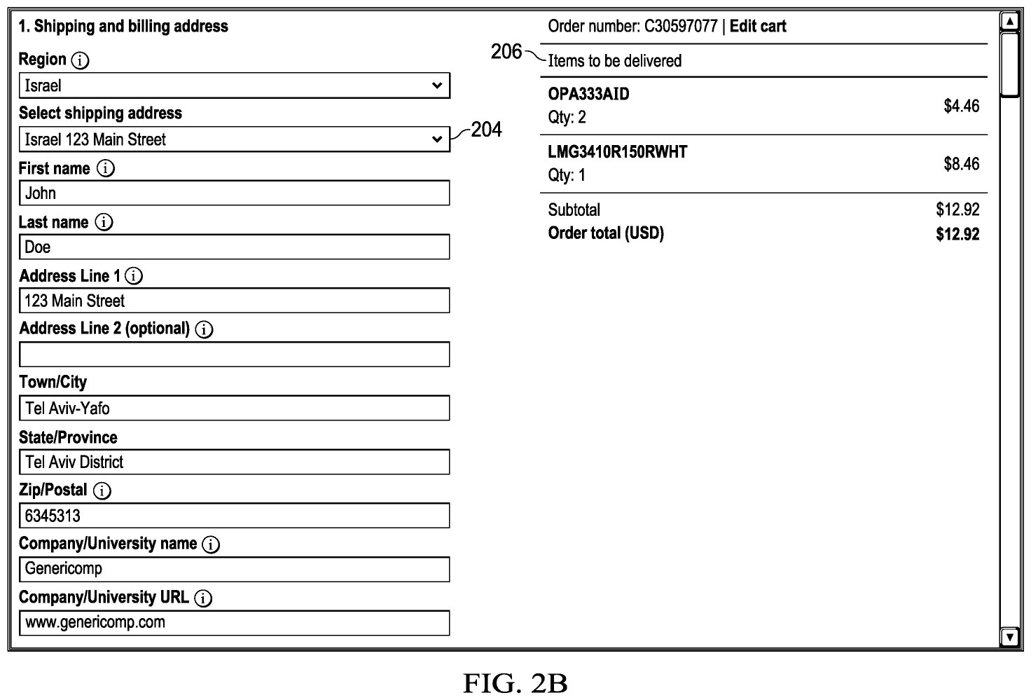

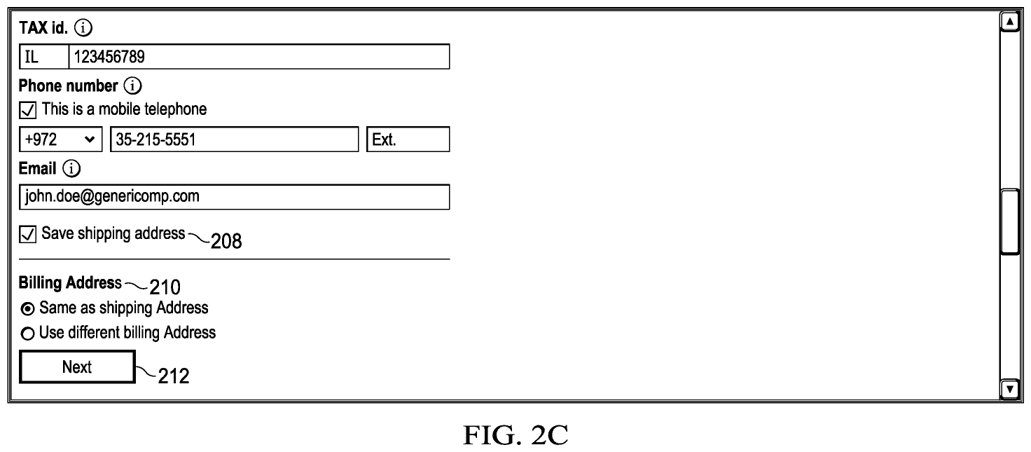

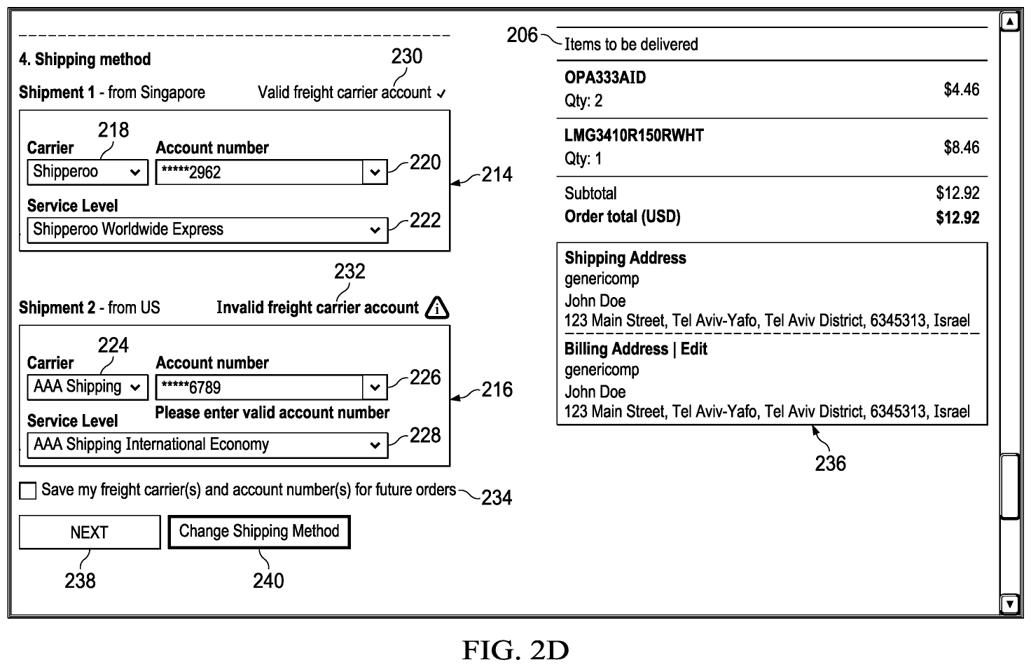

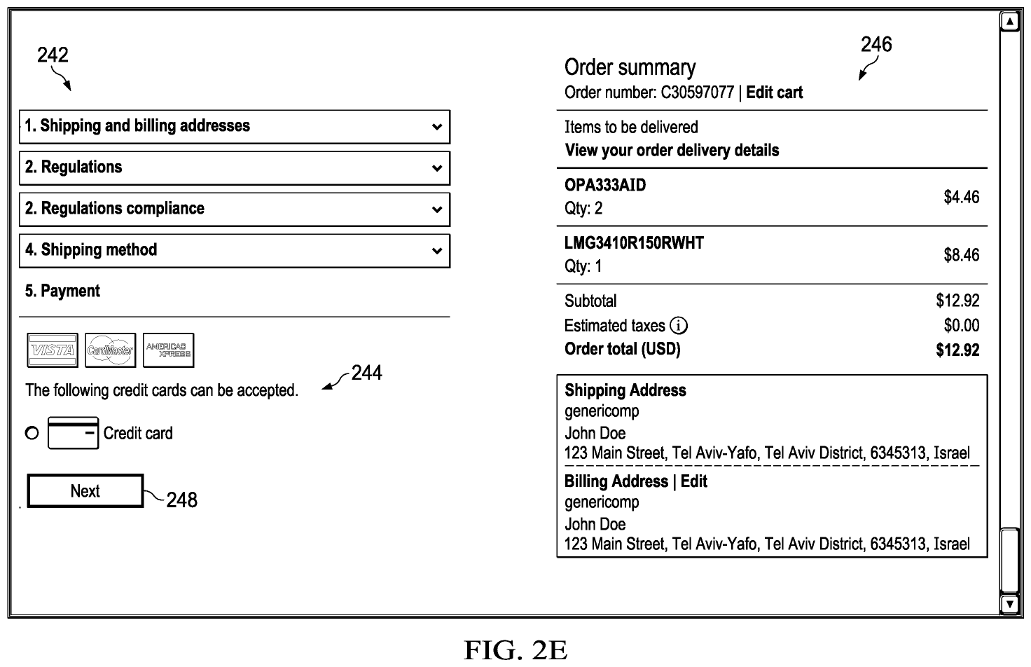

FIG. 1 is a flow diagram of a method for real-time validation of a freight carrier account number during an e-commerce order in accordance with some embodiments. The method is described in reference to FIGS. 2A-2E, which show excerpts of an example graphical user interface (GUI) for an e-commerce website providing real-time validation of freight carrier account numbers. The GUI is displayed in a web page in a web browser on the customer's digital device, e.g., a cellular telephone, a tablet, a laptop, or a desktop computer. The method and the example GUI assume that the customer has completed product selection on the e-commerce website and is ready to checkout. FIG. 2A shows an example virtual shopping cart 200 containing two items the customer has selected for purchase.

Initially, a request from the customer to enter the checkout process is received 100 in the e-commerce website, e.g., by selection of the “Checkout” button 202 displayed with the virtual shopping cart. In response, the e-commerce website transmits customer information to the webpage and a checkout GUI that includes the customer information is displayed 102 in the web page. The customer information may be, for example, previous shipping and billing information saved in a customer profile by the e-commerce website. The checkout GUI may include options for the customer to enter the name of the individual or company to receive the items in the virtual shopping cart, a shipping address, and a billing address.

FIGS. 2B and 2C show an example interface for entering the name and addresses. The example interface includes a shipping address selection field 204 in which the customer can select a previously stored address from a drop down list or enter a new shipping address. In addition, the interface includes a delivery section 206 showing the items to be delivered, a checkbox option 208 for saving the shipping address, and a billing address section 210 with checkbox options for specifying the billing address is the same as the shipping address or specifying that the billing address is different from the shipping address. In this example, the customer has entered a shipping address in Israel and specified that the billing address is the same as the shipping address. The customer may select the “Next” button 212 to move to the next part of the checkout process.

The customer specified shipping address, which may also be referred to as the ship to address herein, is received 104 from the web browser by the e-commerce website. The e-commerce website then determines 106 the ship from address(es), e.g., the location(s) from which the products in the customer's virtual cart will be shipped. In some embodiments, the e-commerce company may have multiple ship from locations, e.g., multiple warehouses, and products in the customer's virtual cart may be shipped from different locations depending on availability. In other embodiments, the e-commerce company may have a single ship from location.

Given the ship to address and the ship from address(es), the e-commerce website then determines 108 the freight carrier option(s) (including service levels) for the shipping route(s) and transmits 110 those options to customer's web browser. The web browser then displays the freight carrier option(s) in the checkout GUI along with a field for entering an account number. If there are multiple freight carriers, the customer may select a freight carrier from the multiple carriers, e.g., from a drop down menu showing the freight carriers. Further, if products in the customer's virtual cart are to be shipped from different locations, freight carrier option(s) are displayed for each ship from location.

FIG. 2D shows an example interface for selecting freight carriers along with specifying account numbers and service levels. The example interface includes shipping method selection sections, e.g., shipping method selection sections 214, 216, for each shipping route to be used to ship the products in the customer's virtual shopping cart. In this example, each of the two products in the customer's shopping cart is being shipped from a different location and thus has a different shipping route. The shipping method selection sections 214, 216 include a carrier selection field 218, 224 in which the customer may select a carrier for the shipping route from a drop down list of available carriers. If only one carrier is available for the shipping route, the drop down list is inactivated and the single carrier is shown in the carrier selection field.

The shipping method selection sections 214, 216 also include an account number selection field 220, 226, that the customer may use to select or enter an account number for the selected carrier. If the customer has previously saved an account number for the selected carrier, that account number is displayed in the account number selection field 220, 226. If the customer has not previously saved an account number for the selected carrier or wants to change the account number, the customer may enter an account number in the account number selection field 220, 226. The shipping method selection sections 214, 216 also include a service level selection field 222, 228 that the customer may use to select a level of service from the selected carrier from a drop down list of service levels. The service levels displayed in the drop down list are limited to the services levels offered by the selected carrier for the shipping route.

In addition, the example interface includes the delivery section 206 showing the items to be delivered, an address section 236 showing the shipping and billing addresses, and a checkbox option 234 for saving the freight carrier(s) and account number(s) for future orders.

Referring again to FIG. 1, the e-commerce website receives 112 the freight carrier(s), associated account number(s), and service level(s) selected by the customer from the web browser. The e-commerce website then validates 114 the account number(s) with the freight carrier(s). In some embodiments, to determine if an account number is valid, the e-commerce website communicates with the freight carrier website to generate a dummy shipping label. For example, the e-commerce website may transmit a request for a shipping label to the freight carrier website that includes the ship from and ship to addresses, a dummy weight and dollar value, the account number, and the service level. In some embodiments, the same dummy weight and dollar value are used for account number validations. In other embodiments, the dummy weight and/or dollar value may be estimated. If the account number is valid, the freight carrier website will transmit the information needed to print the dummy shipping label along with a valid tracking number to the e-commerce website. If the account number is not valid, the freight carrier website sends an indication that the account number is invalid, e.g., a message stating “Account number incorrect or invalid” or “Account number not found.”

If the account number is valid 116, the e-commerce website cancels the dummy shipping transaction with the freight carrier website and allows the customer to complete 120 the checkout process. The actual shipping label is generated after completion of the checkout process. If the account number is not valid 116, the e-commerce website transmits 118 an indication of invalidity to the checkout GUI, which displays an indication of invalidity in the checkout GUI. The customer may then correct the account number, which will cause the repetition of the validation process beginning at step 112.

Referring again to the example interface of FIG. 2D, validation of the carrier account numbers in the shipping method selection sections 214, 216 by the e-commerce website is triggered when the customer selects the “Next” button 238. In this example, the account number entered in the account number selection field 220 of the shipping method selection section 214 is valid and a validity indication 230 is displayed in association with the shipping method selection section 214.

The account number entered in the account number selection field 226 of the shipping method selection section 216 is not valid and an invalidity indication 232 is displayed in association with the shipping method selection section 216 along with a message prompting the customer to enter a valid account number. The customer may enter or select another account number in the account number selection field 226 and again select the “Next” button 238 to trigger another validation. Alternatively, the customer may select the “Change Shipping Method” button 240 to enter information for another shipping method.

If there are valid account numbers in the account number selection fields 220, 226, customer selection of the “Next” button triggers validation of the account numbers by the e-commerce website. When the web browser receives an indication from the website that the account numbers are valid, an interface to complete the checkout process is displayed in the web page. FIG. 2E shows an example interface for completion of the checkout process. The example interface includes a review and edit section 242 that allows the customer to review and/or edit the addresses, shipping methods, etc., a payment section 244 for selection of payment options, and an order summary section 246 showing the items ordered, the cost, and the shipping and billing addresses. The customer may select the “Next” button 248 to enter payment information and complete the order.

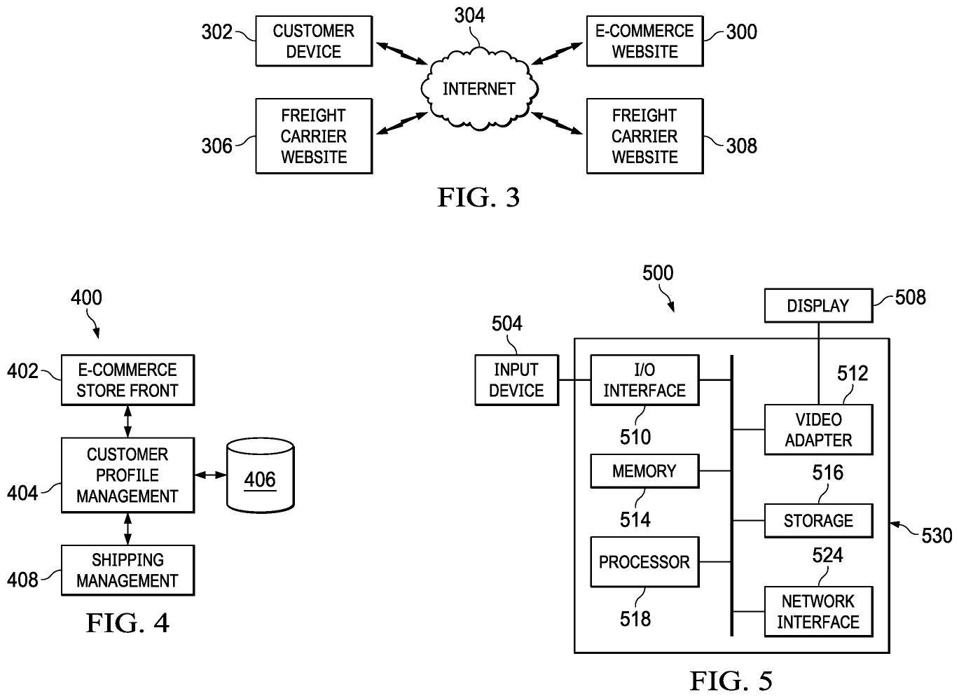

FIG. 3 is a block diagram of an example system configured to perform real-time validation of freight carrier account numbers during an e-commerce order. The system includes an e-commerce website 300 executing on a web server, a customer device 302 coupled to the e-commerce website 300 via the internet 304 and freight carrier websites 306, 308 coupled to the e-commerce website via the internet 304. Connectivity between the customer device 302 and the e-commerce website 300 and between the freight carrier websites 306, 308 and the e-commerce website 300 may be via various combinations of local area networks (LAN) and wireless connections, for example. The example system includes two freight carrier websites for simplicity of illustration. In other embodiments, the e-commerce website 300 may be connected via the internet 304 to more than two freight carrier websites. The web server may be an embodiment of the digital system 500 of FIG. 5.

The customer device 302, which may be an embodiment of the digital system 500 of FIG. 5, hosts a web browser configured receive and execute web page source code generated by the e-commerce website 300 for a checkout GUI as previously described herein. The web page source code, which may be a combination of JavaScript instructions, Hypertext Markup Language (HTML) instructions, and Cascading Style Sheets (CSS) instructions, includes instructions for displaying the checkout GUI in the web page, instructions for modifying the content of the displayed checkout GUI responsive to transmissions from the e-commerce website 300, e.g., to display freight carrier option(s) as previously described herein, and instructions for responding to customer selections and entries in the checkout GUI including transmitting customer selections and entries to the e-commerce website 300, e.g., transmitting customer freight carrier, account number, and service level selections as previously described herein.

The e-commerce website 300 is configured to provide an e-commerce store front including functionality for product ordering and checkout, customer profile management, and shipping management. The e-commerce website 300 is further configured to communicate with the freight carrier websites 306, 308 to validate freight carrier account numbers in real-time during the customer checkout process as previously described herein. An example architecture for the e-commerce website is described in reference to FIG. 4 herein. The freight carrier websites 306, 308 provide one or more application programming interfaces (APIs) for communicating with an e-commerce website to generate shipping labels.

In some embodiments, the e-commerce website 300 is configured to validate a freight carrier account number specified by a customer by communicating with the freight carrier website via a shipping label API provided by the freight carrier website to generate a dummy shipping label for a shipping route between the customer specified ship to location and a ship from location determined by the e-commerce website. Generating a dummy shipping label to validate a freight carrier account number is previously described herein.

FIG. 4 is a block diagram illustrating an example e-commerce website architecture 400 configured to provide real-time validation of freight carrier account numbers during the customer checkout process. The architecture 400 includes an e-commerce storefront component 402, a customer profile management component 404, and a shipping management component 408. The e-commerce storefront component 402 is configured to provide the customer sales interface for the e-commerce company including ordering and checkout functionality as previously described herein. The functionality includes freight carrier logic to determine the ship from address(es) for the products in the customer's virtual shopping cart and to communicate with the customer profile management component 404 to determine the freight carrier options for the shipping route(s) and to validate freight carrier account numbers prior to allowing a customer to complete the checkout process. In some embodiments, the e-commerce storefront component 402 is implemented using SAP® Hybris, also known as SAP® Commerce Cloud. SAP is a registered trademark of SAP SE or its affiliates in Germany and in several other countries.

The customer profile management component 404 is configured to manage profile data of customers of the e-commerce website and to provide customer profile data to the e-commerce store front component 402 to populate fields of the checkout GUI. Customer profile data may include, for example, shipping addresses, billing addresses, and freight carrier account numbers if the customer elects to save this information in the profile. Customer profile data is stored in a customer profile database 406 coupled to the customer profile management component 404.

In addition, the customer profile management component 404 includes functionality to communicate with the shipping management component 408 to determine freight carrier option(s) for shipping routes indicated by the ship from and ship to addresses communicated to the customer profile management component 404 by the e-commerce store front component 402. The customer profile management component 404 further includes functionality to communicate the determined freight carrier options to the e-commerce store front component 402 for inclusion in the checkout GUI.

The customer profile management component 404 also includes functionality to communicate with the shipping management component 408 to validate freight carrier account numbers entered/selected in the checkout GUI and to communicate the result of the validation to the e-commerce store front component 402.

The shipping management component 408 is configured to perform order processing, order shipping, and order billing. Order processing includes generating a sales order capturing a request for goods from a customer which includes pricing, delivery information (dates and quantities), and billing information (terms of payment, etc.). Order shipping includes processes for picking the goods, packing the goods, and arranging for transport and shipment. Order billing includes generation of customer invoices or credit or debit memos to bill the customer for the goods.

The shipping management component 408 includes functionality to determine a shipping route given a ship from and a ship to address and all freight carriers that can service the shipping route and their service levels for the shipping route. The shipping management component 408 further includes functionality to validate customer account numbers with freight carriers as previously described herein.

In some embodiments, the shipping management component 408 is implemented using SAP® ERP Central Component (ECC) with custom extensions to support freight carrier account number validation.

FIG. 5 is a block diagram of an example digital system 500 in accordance with embodiments described herein. The digital system 500 includes a processing unit 530 coupled to one or more input devices 504 (e.g., a mouse, a keyboard, or the like), and one or more output devices, such as a display screen 508. In some embodiments, the display screen 508 may be touch screen, thus allowing the display screen 508 to also function as an input device. The processing unit 530 may be, for example, a desktop computer, a workstation, a laptop computer, a tablet, a dedicated unit customized for a particular application, a server, or the like. The display screen 508 may be any suitable visual display unit such as, for example, a computer monitor, a light emitting diode (LED), liquid crystal display (LCD), or plasma display, a television, a high definition television, or a combination thereof.

The processing unit 530 includes one or more processors 518, memory 514, a storage device 516, a video adapter 512, and an I/O interface 510 connected by a bus. The bus may be one or more of any type of several bus architectures including a memory bus or memory controller, a peripheral bus, video bus, or the like. The processor 518 may be any type of electronic data processor. For example, the processor 518 may be a Reduced Instruction Set Computer (RISC), an Application-Specific Integrated Circuit (ASIC), or the like. The memory 514, e.g., a non-transitory computer-readable medium, can be any type of system memory such as static random access memory (SRAM), dynamic random access memory (DRAM), synchronous DRAM (SDRAM), read-only memory (ROM), a combination thereof, or the like. Further, the memory 514 can include ROM for use at boot-up, and DRAM for data storage for use while executing programs.

The storage device 516, e.g., a non-transitory computer-readable medium, can include any type of storage device configured to store data, programs, and other information and to make the data, programs, and other information accessible via the bus. The storage device 516 may be, for example, one or more of a hard disk drive, a magnetic disk drive, an optical disk drive, a solid state drive, or the like.

The video adapter 512 and the I/O interface 510 provide interfaces to couple external input and output devices to the processing unit 530. The processing unit 530 also includes a network interface 524. The network interface 524 allows the processing unit 530 to communicate with remote units via a network (not shown). The network interface 524 may provide an interface for a wired link, such as an Ethernet cable or the like, and/or a wireless link via, for example, a local area network (LAN), a wide area network (WAN) such as the Internet, a cellular network, any other similar type of network and/or any combination thereof. The digital system 500 may also include other components not specifically shown. For example, the digital system 500 may include power supplies, cables, a motherboard, removable storage media, cases, and the like.

### OTHER EMBODIMENTS

While the disclosure has been described with respect to a limited number of embodiments, those skilled in the art, having benefit of this disclosure, will appreciate that other embodiments can be devised which do not depart from the scope disclosed herein.

It is therefore contemplated that the appended claims will cover any such modifications of the embodiments as fall within the true scope of the disclosure.

What is claimed is:

1. A method comprising:
receiving, by a first device from a second device, a freight carrier for shipping a product and an account number for the freight carrier;
validating, by the first device, the account number by communicating with a third device; and
allowing, by the first device, completion of checkout on the second device in response to successfully validating the account number.

2. The method of claim 1, wherein receiving further comprises receiving responsive to customer entry in a checkout graphical user interface (GUI) on the second device.

3. The method of claim 1, wherein validating further comprises:
transmitting a request for a shipping label to the third device, wherein the request includes the account number; and
determining the account number is valid when information for the shipping label is received from the third device.

4. The method of claim 2, wherein the request further includes a dummy weight, a dummy dollar value, and a service level.

5. The method of claim 2, wherein validating further comprises determining the account number is not valid when an indication of invalidity is received from the third device, and wherein the method further comprises transmitting an indication that the account number is not valid to the second device.

6. The method of claim 1, wherein the freight carrier is selected by a customer in a checkout graphical user interface (GUI) on the second device from one or more freight carriers determined by the first device to service a shipping route between a customer specified ship to address and a ship from address determined by the first device.

7. The method of claim 6, wherein a service level for the freight carrier is selected by the customer in the checkout GUI from one or more service levels of the freight carrier determined by the first device.

8. A first device comprising at least one processor configured to:
receive a freight carrier for shipping a product and an account number for the freight carrier during a checkout process initiated by a second device; and
communicate with a third device to validate the account number before the checkout process can be completed by the second device.

9. The first device of claim 8, wherein the at least one processor is further configured to allow completion of checkout on the second device if the account number is valid.

10. The first device of claim 8, wherein the at least one processor is further configured to validate the account number by transmitting a request for a shipping label to the third device, wherein the request includes the account number, and to determine the account number is valid when information for the shipping label is received from the third device.

11. The first device of claim 10, wherein the request further includes a dummy weight, a dummy dollar value, and a service level.

12. The first device of claim 10, wherein the at least one processor is further configured to determine the account number is not valid when an indication of invalidity is received from the third device, and to transmit an indication that the account number is not valid to the second device.

13. The first device of claim 8, wherein the at least one processor is further configured to determine a ship from address the product and one or more freight carriers that service a shipping route between a customer specified ship to address and the ship from address, and wherein the freight carrier is selected from the one or more freight carriers on the second device.

14. The first device of claim 13, wherein the at least one processor is further configured to determine one or more service levels for each of the one or more freight carriers, and wherein a service level for the freight carrier is selected from the one or more service levels of the freight carrier on the second device.

15. The first device of claim 8, wherein the at least one processor is further configured to provide customer profile data to second device.

16. A method comprising:
displaying a checkout graphical user interface (GUI) responsive to a customer request to enter a checkout process, by at least one processor on a first device;
receiving, by the at least one processor, customer selection of a freight carrier and an account number for the freight carrier in the checkout GUI;
validating the account number by the at least one processor by communicating with a second device; and
displaying, by the at least one processor, an interface to complete the checkout process in the checkout GUI when the second device indicates the account number is valid.

17. The method of claim 16, further comprising displaying, by the at least one processor, an indication that the account number is not valid in the checkout GUI when the second device indicates the account number is not valid.

18. The method of claim 16, wherein customer selection of a freight carrier is from one or more freight carriers determined by the second device to service a shipping route between a ship to address specified by the customer in the checkout GUI and a ship from address determined by the second device.

19. The method of claim 18, wherein receiving further comprises receiving customer selection of a service level for the freight carrier in the checkout GUI, wherein the customer selection of a service level is from one or more service levels of the freight carrier determined by the second device.

20. The method of claim 16, further comprising displaying in the checkout GUI, by the first processor, customer profile data received from the second device.
